(19) United States
(12) Patent Application Publication
(10) Pub. No.: US 2016/0325581 A1
(43) Pub. Date: Nov. 10, 2016

(54) Perforated Pencil Eraser Cap

(71) Applicant: Andrew Jake Floyd, Westport, CT (US)

(72) Inventor: Andrew Jake Floyd, Westport, CT (US)

(21) Appl. No.: 14/703,491

(22) Filed: May 4, 2015

(51) Int. Cl. B43L 19/00

(52) U.S. Cl. CPC B43L 19/0075

(57) ABSTRACT

The least appealing aspect of your typical office/school-used wooden pencil is when you, the user, have used so much of the available eraser on top of the pencil that it can no longer be used. It is now perfectly flush with the top of the metal eraser casing. Now, you can no longer use this eraser even though there may be much more pencil available to be used. What the Perforated Pencil Eraser Cap (PPEC) does is allow you, the user, to tear/peel away the top portion of the metal eraser casing so as to expose more of the eraser found inside of the metal casing. This allows the user of the PPEC and the pencil to use more of their pencil and use their pencil for a longer period of time.

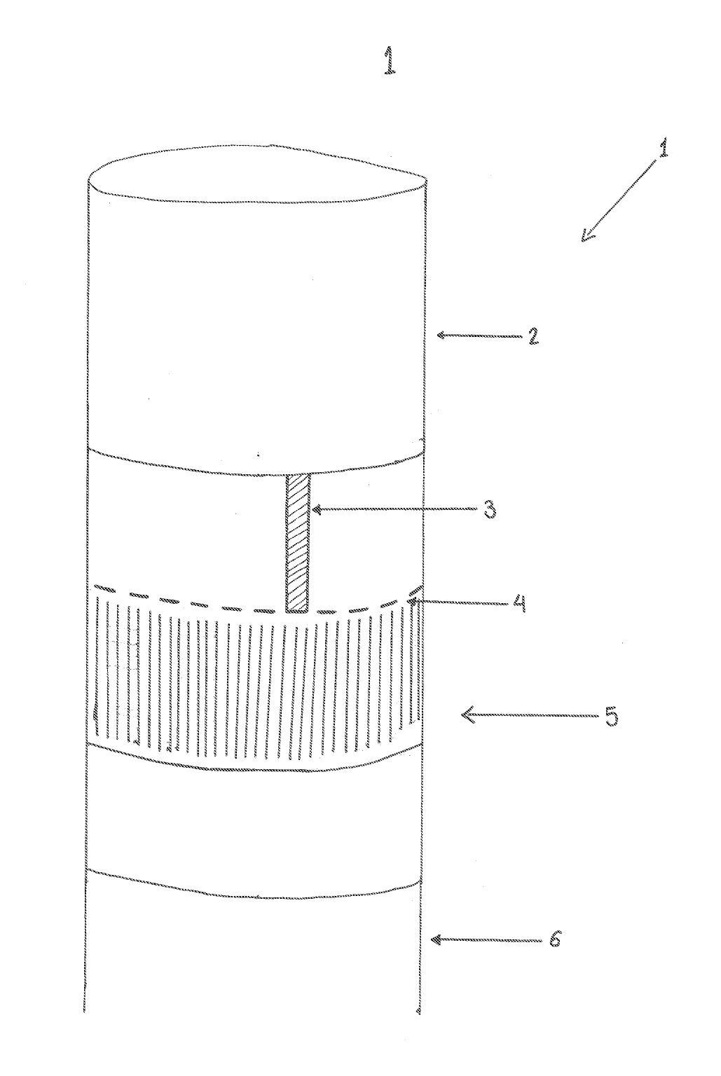

The Perforated Pencil Eraser Cap (PPEC) is the slight perforation of the upper portion of the metal casing of a typical wooden pencil, which contains the eraser. This perforation would be of use when the standard amount of eraser has been used until it is flush with the top of the metal casing, leaving the remaining amount of eraser left inside the metal casing unusable. When this would occur, the perforated portion of the metal casing would be able to be torn/peeled off of the pencil, thus exposing more eraser to be used thereafter.

### BACKGROUND

The PPEC pertains to the office supply/art industry as it is for use on typical pencils. The problem solved with the PPEC is the following: When the user of a typical pencil uses the eraser until it is flush with the top of the metal casing the pencil as a whole loses value; especially when there is still graphite to be used in the wooden portion of the pencil. At this point, essentially half of the pencil's ability has been discarded as now the user can only write/draw with the pencil, but no longer erase his/her mistakes. The PPEC allows for more eraser to be exposed once the original amount has been used up.

### SUMMARY

The PPEC is the existence of perforations along the top portion of the metal casing found at the top of all regular office and school-use pencils. The PPEC allows the user to tear/peel away the perforated uppermost portion of the metal casing that contains the eraser. This allows the user to keep using the pencil as he/she would normally, once the original amount of exposed eraser has been expended.

### BRIEF DESCRIPTION OF DRAWING

The drawing is of the top portion of a typical wood pencil.

Reference character 1: Points to the top portion of the wood pencil as a whole.
Reference character 2: Points directly to the pencil's eraser.
Reference character 3: Points directly to the opening portion of the PPEC where the beginning of the tearing/peeling away process would occur. This opening portion would essentially be an absence of the metal eraser casing so something similar to a fingernail could be inserted to begin the tearing/peeling away process of the PPEC (Thinner lines are drawn to show difference and shading).
Reference character 4: Points directly to the perforations in the metal eraser casing where the actual tearing/peeling is occurring (Thicker lines are drawing to show difference).
Reference character 5: Points to the portion of the pencil referred to here as the “metal eraser casing”.
Reference character 6: Points directly to the wooden portion of the pencil.

### DETAILED DESCRIPTION

The Perforated Pencil Eraser Cap is the existence of perforations along the top portion of the metal eraser casing found at the top of all regular office and school-use pencils. The perforations in the metal eraser casing allow the user to, once the original amount of exposed eraser has been used completely, tear/peel away the upper portion of the metal eraser casing so more eraser becomes exposed and available for use. The PPEC would be manufactured by simply piercing/cutting “holes” or “slits” into the metal eraser casing and creating a vertical opening between the eraser and perforations. The vertical opening portion would be to help begin the tearing/peeling off process of the top portion of the metal eraser casing for the user. It is thought that without a beginning point to tear/peel away the metal eraser casing, the PPEC would be rather irritable to try to use.

1. The perforations in the upper portion of the metal eraser casing.

2. The opening portion of the upper portion of the metal eraser casing.
a. The opening portion is unique in the facet that it allows an easy access-point for the user to begin the tearing/peeling away process of the PPEC.
